(19) United States
(12) Patent Application Publication
(10) Pub. No.: US 2006/0181989 A1
(43) Pub. Date: Aug. 17, 2006

(54) System and/or method for adjusting a laser beam

(76) Inventors: D. Mitchel Hanks, Fort Collins, CO (US); Kevin L. Colburn, Greeley, CO (US); Lawrence N. Taugher, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/045,228

(22) Filed: Jan. 27, 2005

(51) Int. Cl. G11B 7/00

(52) U.S. Cl. 369/47.55

(57) ABSTRACT

Embodiments of methods, apparatuses, devices and systems associated with a system and/or method for adjusting a laser beam.

### BACKGROUND

Opto-mechanical systems such as compact disc read/write drives, compact disc read/re-writable drives, DVD read/write drives, DVD read/re-writable drives, and/or other opto-mechanical drives may be used to write data, which can include a wide variety of information, to a data side of an optical storage disc.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a schematic diagram of an embodiment of a system, such as an opto-mechanical system for writing data to a label side of an optical storage disc;

FIG. 2 is a flow chart diagram depicting an embodiment of a method of adjusting a laser of the system of claim 1;

FIG. 3 is a diagram of an embodiment of an opto-mechanical system employed as an internal drive of a desktop computing device;

FIG. 4 is a diagram of an embodiment of an opto-mechanical system employed as an external drive of a laptop computing device;

FIG. 5 is a schematic diagram of an embodiment of a computer program for implementing a method in accordance with an embodiment.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

Recently, new adapted drives have been able to write optically visible markings, such as images and/or other data to a label side of an optical storage disc. The label side under these circumstances may comprise electromagnetic radiation and/or heat responsive materials. However, absorption properties of these electromagnetic radiation and/or heat responsive materials may vary over the surface of the label side, and/or may be influenced by external environmental conditions. In addition, properties of a laser beam, such as wavelength and/or power, produced by a laser of the opto-mechanical system may vary over time, which may in turn affect the absorption properties of the electromagnetic radiation and/or heat responsive materials on the label side. This effect may in turn degrade the image quality of the optically visible markings formed on the label side.

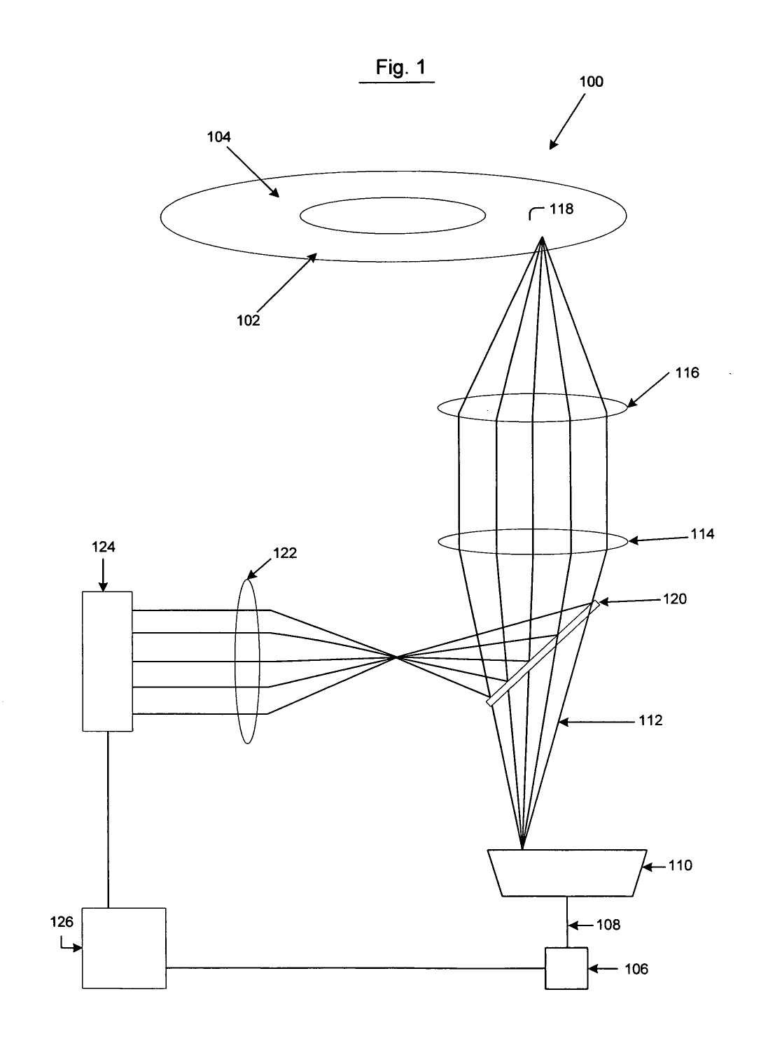

FIG. 1 is a schematic diagram of an embodiment of a system 100, such as an opto-mechanical system, for example, for writing data to a label portion 102 of an optical storage medium 104, such as a disc. Optical storage medium 104 may be any of a wide variety of storage mediums such as, but in no way limited to, a writable compact disc, a re-writeable compact disc, writable DVD, a re-writable DVD, and/or any other medium wherein data may be stored by electromagnetic radiation. In this context label portion 102 may comprise a non-data side of optical storage medium 104, such as a portion on which a label indicating any content of a data side may be placed without interfering with reading and/or writing to the data side. In addition, label portion 102 may further comprise an electromagnetic radiation and/or heat responsive material and/or materials, as discussed further below. Optical storage medium 104 may be inserted into, and/or removed from, system 100. System 100 may be used for reading and/or writing optically visible markings (not shown), such as images, information, and/or other data, to label portion 102 of optical storage medium 104, for example.

System 100 may comprise a laser 106, such as a laser diode and/or any other device and/or structure that is capable of generating a laser beam and/or pulse. Laser 106 may be operable to output a laser beam 108. Laser beam 108 may have a wavelength in the approximate range of 780 nm, though other wavelength ranges may be used without departing from the scope of the claimed subject matter. It should be noted that the 780 nm range is provided by way of example and is in no way a limitation of the claimed subject matter. Label portion 102 may comprise electromagnetic radiation and/or heat absorbing and/or reactive materials along with other materials coated onto a non-data side and/or non-data portion (not shown) of optical storage medium 104 and/or coated and/or affixed on a material such as paper, metal, and the like that may be affixed to and/or over the non-data side and/or non-data portion of optical storage medium 104. The electromagnetic radiation and/or heat absorbing and/or reactive materials may be such that the electromagnetic radiation and/or heat absorbing and/or reactive materials may change color, contrast, and/or other measurable and/or optically detectable properties in response to laser beam 108. The electromagnetic radiation and/or heat absorbing and/or reactive materials may be designed such that they respond efficiently to light having an approximate wavelength range, such as the approximately 780 nm range discussed above with regard to laser 106, for example.

As discussed above, label portion 102 may comprise electromagnetic radiation and/or heat absorbing and/or responsive materials along with other materials on a portion of optical storage medium 104 such that label portion 102 may not interfere with reading, writing, and/or re-writing data to a data portion of optical storage medium 104. The term electromagnetic radiation and/or heat absorbing and/or reactive materials may, in this context, mean any electromagnetic and/or heat absorbing and/or reactive materials wherein the materials and/or compound may readily absorb a specific desired wavelength range and/or approximate wavelength of electromagnetic radiation. The electromagnetic radiation and/or heat absorbing and/or reactive materials may comprise, but are not limited to, any of the following: IR780 (Aldrich 42,531-1) (1) (3H-Indolium, 2-[2-[2-chloro-3-[1,3-dihydro-3,3-dimethyl-1-propyl-, iodide (9CI)); IR783 (Aldrich 54,329-2) (2) (2-[2-[2-Chloro-3-[2-[1,3-dihydro-3,3-dimethyl-1-(4-sulfobutyl)-2H-indol-2-ylidene]-ethylidene]-1-cyclohexen-1-yl]-ethenyl]-3,3-dimethyl-1-(4-sulfobutyl-3H-indolium hydroxide, inner salt sodium salt)); Syntec 9/1 (3)0; Syntec 9/3 (4); metal complexes (e.g., dithiolane metal complexes (5); and indoaniline metal complexes (6)) may be suitable radiation and/or heat absorbing and/or reactive materials and/or compounds; and/or any combinations thereof, for example.

Other materials that may be present on label portion 102 may include, but are in no way limited to, UV curable monomers, oligomers, and/or pre-polymers (e.g. acrylic derivatives). UV curable monomers, oligomers, and/or pre-polymers may comprise, but are in no way limited to, hexamethylene diacrylate, tripropylene glycol diacrylate, lauryl acrylate, isodecyl acrylate, neopentyl glycol diacrylate, 2-phenoxyethyl acrylate, 2-(2-ethoxy) ethylacrylate, polyethylene glycol diacrylate and other acrylated polyols, trimethylpropane triacylate, pentaerythritol tetraacrylate, ethoxylated bisphenal, and a diacrylate, acrylic oligomers with epoxy functionality, and the like.

The above materials are provided by way of example and are not in any way intended to limit the scope of the claimed subject matter. Other suitable materials exist and may be used. In addition, other materials may be more suited to particular approximate wavelength ranges.

System 100 may, in the case where system 100 is an opto-mechanical system, further include a diffraction grating 110, for example. Diffraction grating 110 may operate to separate laser beam 108 into a plurality of laser beam components 112. Diffraction grating 110 is just one example of a mechanism for separating laser beam 108 into laser beam components 112. Other mechanism may be employed to the same effect, such as a beam splitter (not shown) and/or a prism (not shown), for example. System 100, in this context, may further include a collimator lens 114, for example. Laser beam components 112 may pass through collimator lens 114 to collimate laser beam components 112. System 100, in this context, may further include an objective lens 116, for example, which may be operable to focus laser beam components 112 onto a track 118, which could be a single track and/or a plurality of tracks, defined on label portion 102 of optical storage medium 104, for example.

The tracks, such as track 118, of label portion 102 of optical storage medium 104 may reflect at least in part laser beam components 112. The at least in part reflected laser beam components 112 may be at least in part directed back through objective lens 114. System 100 may, in this context, further include a beam splitter 120. Beam splitter 120 may operate to at least in part redirect the at least in part reflected laser beam components 112 towards a photodetector lens 122, for example. Photodetector lens 122 may then operate to at least in part collimate the at least in part reflected laser beam components 112 onto a photodetector array 124, such as a multi-beam detector array, for example. Photodetector array 124 may include an individual detector for each of the at least in part reflected laser beam components 112, though that is just an example and in no way limits the scope of the claimed subject matter. Photodetector array 124 may detect and/or measure the laser beam components 112 that were at least in part reflected by label portion 102 of optical storage disc 104.

System 100 was described above in the context of an opto-mechanical storage system. The components described were provided by way of example for an opto-mechanical system and are in no way intended, nor should they be interpreted, to limit the scope of system 100 and/or the scope of the claimed subject matter. Many other systems may utilize and/or be utilized with and/or by the claimed subject matter. In addition, opto-mechanic systems may utilize different and/or additional components without departing from the spirit and/or scope of the claimed subject matter.

System 100 may further include a controller 126, for example. Controller 126 may be implemented as firmware, hardware, software, and/or any combination thereof. Controller 126, as discussed more fully below, may be operable to measure the at least in part reflected laser beam component 112 detected by photodetector array 124 at a first time, such as a reference time to determine a reference feedback signal and/or reference absorption, and at a second time, such as an operation time to determine an operation feedback signal and/or operational absorption. Controller 126 may be further operable to compare the measured at least in part reflected laser beam components 112 at the reference time to the measured at least in part reflected laser beam components 112 at the operation time. In addition, controller 126 may include a stored reference signal, such as a predetermined calibrated and/or averaged reference signal. In this context, controller 126 may compare the stored reference signal to the determined operation feedback signal. Additionally, controller 126 may be operable to average the measured at least in part reflected laser beam components 112 at a plurality of reference times to determine an average reference signal. In this context controller 126 may be further operable to compare the average reference signal to the operation feedback signal. As more fully discussed below, controller 126 may be further operable to adjust laser 106 such that a property of laser beam 108, such as power and/or frequency, is modified in response to a difference between the reference signal, whichever type of reference signal may be used, and the operation feedback signal. The above description of controller 126 was provided by way of example and not limitation. A wide variety of techniques may be used to determine a reference signal and an operation feedback signal at a variety of times, the specific time and techniques discussed above are merely examples and in no way limit the scope of the claimed subject matter.

Laser beam components 112 may serve a variety of different purposes. For example, in the case in which laser 106 produces a relatively high power laser beam 108, then laser beam components 112 may be used to write data, such as images, information, and/or other data in an optically visible form to label portion 102 of optical storage medium 104. For example, in the case in which laser 106 produces a relatively low power laser beam 108, then laser beam components 112 may be used to read data, such as images, information, and/or other data from label portion 102 of optical storage medium 104.

Changes to the system 100 may be made without departing from the spirit and/or scope of the claimed subject matter. For example, a physical and/or optical ninety-degree rotation of the photodetector array may be employed. Thus, photodetector array 124 may be positioned perpendicular to a tangential direction of optical storage medium 104, for example. For additional example, photodetector array 124 may be physically and/or optically rotated more or less than ninety degrees, for improving image quality, light-media interaction calibration (LMIC), or other aspects and attributes of the system 100, for example.

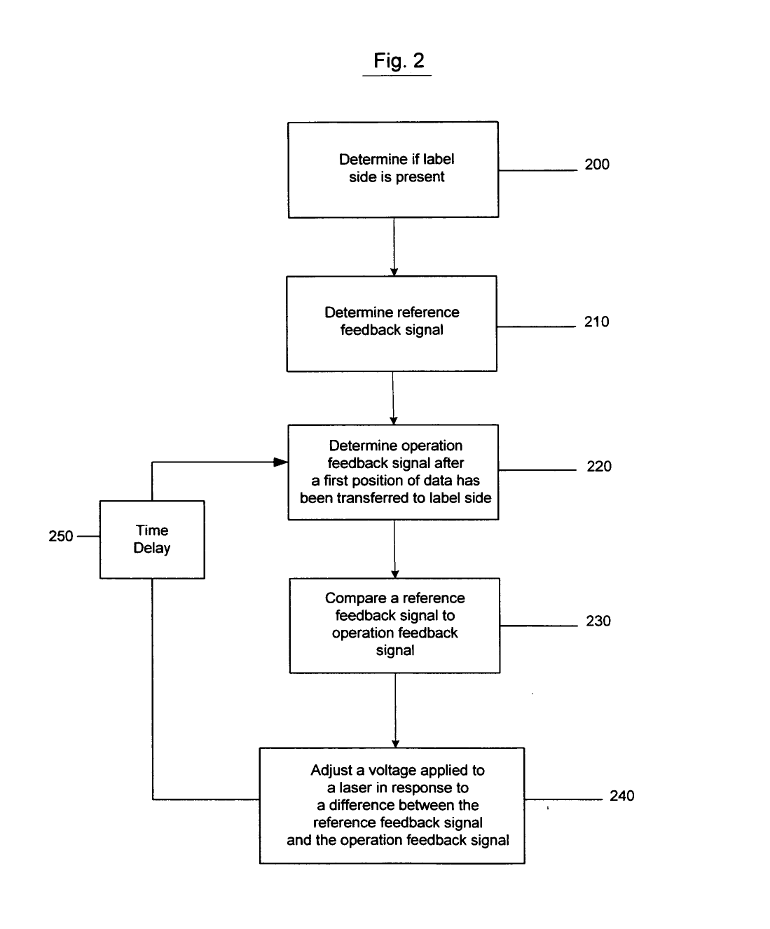

FIG. 2 is a flow chart diagram depicting a method of adjusting laser 106 of system 100. With reference to box 200, in response to optical storage medium 104 being placed in and/or on system 100, controller 126 may initiate a process by which system 100 determines that a label portion of an optical storage medium is present. If system 100 determines that label portion 102 of optical storage medium 104 is present then system 100 will proceed to determine a reference feedback signal at a reference time, or as discussed above determine an average reference signal or access a stored reference signal. As discussed more fully below the reference time can be any time before and/or after system 100 has begun transferring data to label portion 102 of optical storage disc 104.

With reference to box 210, in determining a reference feed back signal, controller 126 may activate laser 106. Laser 106 may then generate a laser beam 108. Laser beam 108 may be separated into a plurality of laser beam components 112. Collimator lens 114 and objective lens 116, may, in conjunction, focus laser components 112 onto a track, such as track 118, of label portion 102 of optical storage medium 104. Track 118 may be an unlabelled region of label portion 102. At least a portion of laser components 112 may then be reflected by label portion 102 of optical storage medium 104. The reflected portion of laser components 112 may then pass back through objective lens 116 and collimator lens 114. The reflected portion of laser components 112 that are incident on beam splitter 120 may then be redirected towards photodetector lens 122. Photodetector lens 122 may operate to focus the reflected portion of laser components 112 onto photodetector array 124. Photodetector 124 may detect any incident laser components 112 of the reflected portion of laser components 112. Controller 126 may then measure the detected incident laser components 112 of the reflected portion of laser components 112. The measuring may be of an electric signal generated by photodetector array 124. Controller 126 may then sum the measurement of the detected incident laser components 112 of the reflected portion of laser components 112 from any and/or all of the photodetectors of photodetector array 124 in response to the incident laser components 112. The sum of the measurement of the detected incident laser components 112 of the reflected portion of laser components 112 may then be used as a reference feedback signal. In this way the reference feedback signal may be at least somewhat proportional to an absorption rate and/or responsiveness of label portion 102 of optical storage medium 104 to laser components 112.

In addition, the reference feedback signal may be determined and/or calibrated prior to any data being written to label portion 102 of optical storage medium 104. Alternatively the reference feedback signal may be determined while a first portion of data is being writing to label portion 102 of optical storage medium 104. In addition, the reference feedback signal may be determined after a first portion of data has been written to label portion 102 of optical storage medium 104. In essence the reference feedback signal may be determined at any time before and/or after a first portion of data has been transferred to label portion 102 of optical storage medium 104. In addition controller 126 may average the measurements of the detected incident laser components 112 of the reflected portion of laser components 112 over a period of time and used the average as a reference feedback signal. In addition, controller 126 may include a stored reference signal, which may be included at the time of manufacture or at a later time or may be determined during operation of system 100.

Once the reference feedback signal has been determined, a portion of data may be written to label portion 102 of optical storage medium 104. With reference to box 220, after said portion of data has been written controller 126 may initiate the process of determining an operation feedback signal. At an operation time, which may be predetermined and/or may be determined on the fly during operation of system 100, and typically while the laser beam is focused on an unlabelled region or track 118 of the label portion 102, controller 126 may again measure any incident laser components 112 of the reflected portion of laser components 112 detected by photodetector array 124 at the operation time. The measuring may, as described above, be of an electric signal generated by photodetector array 124 in response to detected reflected portions of laser components 112. Controller 126 may then sum the measurement of the detected incident laser components 112 of the reflected portion of laser components 112 from any and/or all of the photodetectors of photodetector array 124 at the operation time. The sum of the measurement of the detected incident laser components 112 of the reflected portion of laser components 112 may then be used as the operation feedback signal. In this way the operation feedback signal, in a manner similar to and/or the same as the reference feedback signal, may at least in part be somewhat proportional to an absorption rate and/or responsiveness of label portion 102 of optical storage medium 104.

With reference to box 230, controller 126 may then compare the reference feedback signal to the operation feedback signal. Any difference between the reference feedback signal and the operation feedback signal may at least in part correspond to a change in the absorption rate and/or other responsive properties of label portion 102 of optical storage medium 104. Differences in the absorption rate and/or other responsive properties of label portion 102 may be due to a wide range of factors including, but not limited to, changes in laser wavelength, changes in laser power, inconsistencies in the electromagnetic radiation and/or heat absorbing materials on label portion 102 of optical storage medium 104, and/or changes in environmental conditions such as temperature, to name but a few examples. With reference to box 240, controller 126 may, in response to a difference in the absorption rate and/or other responsive properties of label portion 102 of optical storage medium 104 at the reference time (or the other possible reference feedback signals discussed above) and the absorption rate and/or other responsive properties of label portion 102 of optical storage medium 104 at the operation time, adjust a property of laser beam 108, such as power and/or wavelength, such as by varying a signal applied to laser 106. Changes to laser beam 108 may be proportional to any difference between the reference feedback signal and the operation feedback signal. In addition, changes to laser beam 108 may be proportional to changes in the signal applied to laser 106. In this way adjustments to laser beam 108 and corresponding changes in any signal applied to laser 106, may be at least in part proportional to any change in the absorption rate and/or other responsive properties of label portion 102 of optical storage medium 104.

In one embodiment, the change in the absorption rate and/or other responsive properties of label portion 102 of optical storage medium 104 may be caused by a change in the wavelength of laser beam 108 as laser 106 heats up, typically during operation. If the laser wavelength is not controllably adjustable, then the laser power may be adjusted instead an amount based on the difference between the reference feedback signal and the operating feedback signal so as to minimize any change in the absorption rate and/or other responsive properties and thus form markings of high image quality on the label portion 102.

It should be noted that both the reference feedback signal and the operation feedback signal may be determined at a plurality of times throughout and/or, in the case of the reference signal, before operation of system 100. With reference to FIG. 2, controller 126 may transition system 100 from box 240 to box 250 and then back to box 220, such as after a time delay, as shown in box 250. In this context a time delay may comprise a predetermined delay for an amount of time, a calculated delay for an amount of time, such as calculated based at least in part on prior need for adjustment, for example, a delay for a randomly determined amount of time, and/or a delay for any desired, calculated and/or determined amount of time, to name but a few examples. In addition, system 100 may switch between different time delays as needed and/or desired. In this way system 100, and/or controller 126, may periodically and/or continually adjust laser beam 108 to compensate for changes in the absorption rate and/or other responsive properties of label portion 102 of optical storage medium 104. As discussed above, changes in the absorption rate and/or other responsive properties of label portion 102 may be due to a variety of factors.

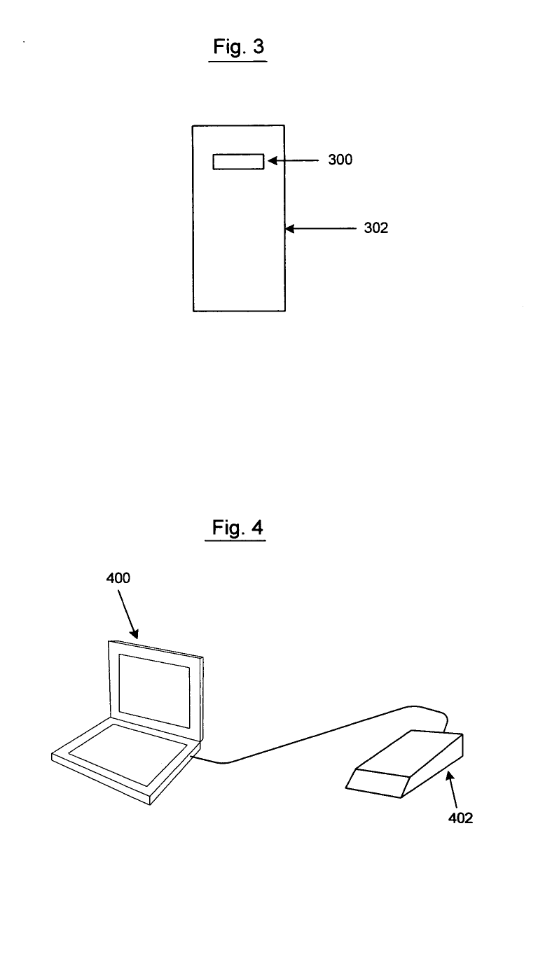

System 100 may be used with a wide variety of computing devices, such as those shown in FIG. 3 and FIG. 4. With reference to FIG. 3, system 100 may comprise an opto-mechanical drive that may be included as an internal drive 300 of a desktop computing device 302. Desktop computing device 300 may be a personal computer, wherein internal drive 300 is internally coupled to desktop computing device. With reference to FIG. 4, system 100 may be an opto-mechanical drive and may be operably coupled to a laptop personal computer 400 as either an external drive 402 or an internal drive (not shown). In addition, system 100 may additionally be used in conjunction with a variety of other computing devices such as stereo equipment, CD players, DVD players, and/or home entertainment systems to name but a few examples.

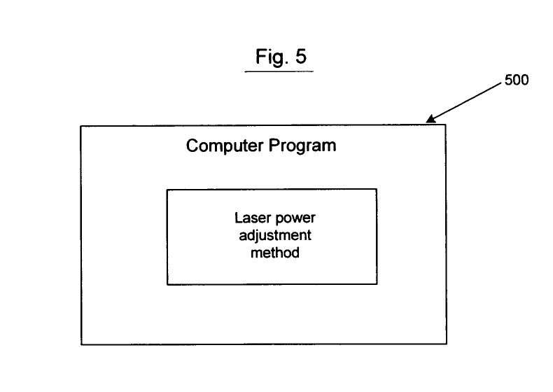

FIG. 5 depicts a schematic diagram of a computer program 500. Computer program 500 may comprise a set of computer readable instructions stored on a computer readable medium, and/or downloadable from a computer network. The set of computer readable instructions may be operable to instruct a computing device to implement embodiments of a method for adjusting a laser beam, such as embodiments described more fully above with reference to FIG. 2.

It will, of course, also be understood that, although particular embodiments have just been described, the claimed subject matter is not limited in scope to a particular embodiment or implementation. For example, one embodiment may be in hardware, such as implemented on a device or combination of devices, as previously described, for example. Likewise, although the claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method of adjusting a laser beam such as by adjusting a signal applied to a laser in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example. In addition, while the invention has been previously described with regard to forming markings on storage media such as optical discs, the invention may also be used with regard to forming markings on other media such as paper or plastic substrates containing or coated with electromagnetic radiation or heat absorbing materials as have been described.

In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

1. A method comprising:
adjusting a laser beam based, at least in part, on a change in an optically visible response of a material to a change in wavelength of said laser beam, said material disposed on a portion of a medium.

2. The method of claim 1, wherein the response is indicative of an absorption of said laser beam by said material.

3. The method of claim 2, wherein said absorption is dependent on a wavelength of said laser beam.

4. The method of claim 1, wherein said medium is an optical disc storage medium.

5. The method of claim 1, wherein said portion of said storage medium comprises a label portion.

6. The method of claim 2, wherein said adjusting a laser beam comprises adjusting a signal applied to a laser.

7. The method of claim 6, wherein said adjusting said signal applied to said laser comprises adjusting a power of said signal so as to compensate for said change in said wavelength.

8. The method of claim 5, and further comprising determining said change in said response of said material.

9. The method of claim 6, wherein said determining said change in said response of said material comprises comparing a reference feedback signal to an operation feedback signal.

10. The method of claim 9, wherein said change in said response corresponds to said operation feedback signal being larger than said reference feedback signal and wherein adjusting said signal applied to said laser comprises increasing a power of said signal applied to said laser.

11. The method of claim 9, wherein said change in said response corresponds to said operation feedback signal being smaller than said reference feedback signal and wherein adjusting said signal applied to said laser comprises decreasing a power of said signal applied to said laser.

12. The method of claim 9, and further comprising:
determining said reference feedback signal for a first unwritten region of said label portion of said storage medium; and
determining said operation feedback signal for a second unwritten region of said label portion of said storage medium after a first portion of data has been written to said label portion by said laser beam.

13. The method of claim 12, wherein said determining said reference feedback signal comprises measuring a quantity of electromagnetic radiation reflected by said label portion.

14. The method of claim 13, wherein said determining said operation feedback signal comprises measuring a quantity of electromagnetic radiation reflected by said label portion.

15. The method of claim 12, wherein said determining said reference feedback signal comprises measuring a plurality of quantities of electromagnetic radiation reflected by said label portion.

16. The method of claim 15, wherein said plurality of quantities of electromagnetic radiation comprise a first, a second, a third, and/or a fourth quantity of electromagnetic radiation reflected by said label portion.

17. The method of claim 15, wherein said determining said reference feedback signal further comprises summing the measured plurality of quantities of electromagnetic radiation reflected by said label portion.

18. The method of claim 17, wherein said determining said operation feedback signal comprises measuring a plurality of quantities of electromagnetic radiation reflected by said label portion.

19. The method of claim 18, wherein said determining the operation feedback signal further comprises summing the measured plurality of quantities of electromagnetic radiation reflected by said label portion.

20. The method of claim 18, wherein said plurality of quantities of electromagnetic radiation comprise a first, a second, a third, and/or a fourth quantity of electromagnetic radiation reflected by said label portion.

21. An apparatus comprising:
a controller capable of adjusting a laser beam at least in part in response to a change induced by a change in a wavelength of said laser beam in an optically detectable property of a label portion of a medium.

22. The apparatus of claim 21 wherein the controller is further capable of comparing a reference feedback signal to an operation feedback signal to determine said change induced by said change in a wavelength of said laser beam in an optically detectable property of said label portion.

23. The apparatus of claim 22, wherein said controller is further capable of measuring detected electromagnetic radiation reflected by said label portion at an operation time to determine the operation feedback signal.

24. The apparatus of claim 23, wherein said controller is further capable of measuring detected electromagnetic radiation reflected by said label portion at a reference time to determine the reference feedback signal.

25. The apparatus of claim 24, and further comprising a plurality of photodetectors in a configuration to detect a quantity of electromagnetic radiation reflected by said label side at a plurality of times.

26. The apparatus of claim 25, wherein said plurality of photo detectors are further in a configuration to detect a plurality of components of said reflected electromagnetic radiation.

27. The apparatus of claim 26, wherein said controller is further capable of summing the detected and measured plurality of components of said reflected electromagnetic radiation and comparing the summed, detected, and measured plurality of components of said reflected electromagnetic radiation at said reference time and at said operation time.

28. The apparatus of claim 27, wherein adjusting said laser beam comprises increasing a power applied to a laser is response to the summed, detected and measured plurality of components of said reflected electromagnetic radiation at said operation time being larger than the summed, detected and measured plurality of components of said reflected electromagnetic radiation at said reference time.

29. The apparatus of claim 27, wherein adjusting said laser beam comprises decreasing a power applied to a laser is response to the summed, detected and measured plurality of components of said reflected electromagnetic radiation at said operation time being smaller than the summed, detected and measured plurality of components of said reflected electromagnetic radiation at said reference time.

30. A system comprising:
a computing device; and
a storage system capable of communicating with the computing device and comprising a laser, wherein said storage system is operable to record data from the computing device as optically visible markings on a label portion of a storage medium, and further operable to adjust said laser at least in part in response to a change in a wavelength of a laser beam generated by said laser and/or a change in a detected aspect of said label portion.

31. The system of claim 30, wherein said storage system further comprises:
a plurality of photodetectors in a configuration to detect a portion of electromagnetic radiation reflected by said label portion at a plurality of times.

32. The system of claim 31, wherein said plurality of times comprises a reference time and an operation time.

33. The system of claim 32, wherein said storage system further comprises:
a controller operable to compare the detected portion of electromagnetic radiation from said reference time to the detected portion of electromagnetic radiation from said operation time.

34. The system of claim 33, wherein said plurality of photodetectors are further in a configuration to detect a plurality of portions of electromagnetic radiation reflected by said label portion at said reference time and said operation time.

35. The system of claim 34, wherein said controller is further capable of summing said detected plurality of portions of electromagnetic radiation at said reference time and at said operation time, respectively.

36. The system of claim 35, wherein said controller is further capable of comparing the sum of the detected plurality of portions of electromagnetic radiation from said reference time to the sum of the detected plurality of portions of electromagnetic radiation from said operation time.

37. The system of claim 36, wherein said controller is further operable to adjust said laser at least in part in response to a change in a wavelength of a laser beam generated by said laser, determined at least in part by a difference between the sum of the detected plurality of portions of electromagnetic radiation from said reference time and the sum of the detected plurality of portions of electromagnetic radiation from said operation time.

38. The system of claim 37, wherein said controller is operable to adjust said laser to compensate for said change in a wavelength of a laser beam generated by said laser at least in part by adjusting a signal applied to said laser.

39. An apparatus comprising:
a data writing means for transferring data to a label portion of a storage medium;
a feedback measuring means for measuring a property of said label portion; and
a controller means for adjusting the data writing means in response to a change in said property of said label portion.

40. An article comprising a storage medium having stored thereon instructions that when executed result in performance of the following method:
adjusting a laser beam based, at least in part, on a change in a wavelength of said laser beam, and/or at least in part, on a change in a response of a material to said laser beam, said material disposed on a portion of a storage medium.

41. The article of claim 40, wherein said adjusting a wavelength of a laser beam a laser beam comprises adjusting a signal applied to a laser.

42. The article of claim 41, wherein said method further comprises determining said change in said response of said material.

43. The article of claim 42, wherein said determining said change in said response of said material comprises comparing a reference feedback signal to an operation feedback signal.

44. The article of claim 43, wherein said method further comprises:
determining said reference feedback signal for said material; and
determining said operation feedback signal for said material after a first portion of data has been written to said material by said laser beam.

45. The article of claim 44, wherein said determining said reference feedback signal comprises measuring a quantity of electromagnetic radiation reflected by said material.

46. The article of claim 44, wherein said determining said operation feedback signal comprises measuring a quantity of electromagnetic radiation reflected by said material.

47. The article of claim 44, wherein said determining said reference feedback signal comprises measuring a plurality of quantities of electromagnetic radiation reflected by said material.

48. The article of claim 47, wherein said plurality of quantities of electromagnetic radiation comprise a first, a second, a third, and/or a fourth quantity of electromagnetic radiation reflected by said label portion.

49. The article of claim 47, wherein said determining said reference feedback signal further comprises summing the measured plurality of quantities of electromagnetic radiation reflected by said material.

50. The article of claim 49, wherein said determining said operation feedback signal comprises measuring a plurality of quantities of electromagnetic radiation reflected by said material.

51. The article of claim 50, wherein said determining the operation feedback signal further comprises summing the measured plurality of quantities of electromagnetic radiation reflected by said material.

52. The article of claim 51, wherein said pluralities of quantities of electromagnetic radiation comprise a first, a second, a third, and/or a fourth quantity of electromagnetic radiation reflected by said material.

53. A method for producing optically-visible markings on laser-sensitive material on a medium, comprising:
determining a reference absorption of laser energy at a first power level and a first wavelength by an unmarked portion of the laser-sensitive material;
determining an operational absorption of laser energy at the first power level and a second wavelength by another unmarked portion of the laser-sensitive material; and
adjusting the laser energy to a second power level at the second wavelength, the second power level determined at least in part from the reference absorption and the operational absorption.

54. The method of claim 53, and further comprising:
marking a portion of the laser-sensitive material before the determining an operational absorption.

55. The method of claim 54, and further comprising:
after a time delay, repeating the marking, the determining an operational absorption, and the adjusting.

56. An apparatus comprising:
a data storage device operable to generate an optically viewable mark on a light and/or heat sensitive material disposed on a storage medium in response to a laser beam applied to said light and/or heat sensitive material, said data storage device further operable to adjust said laser beam in response to a change in a wavelength of said laser beam and/or an associated change in an absorption of said laser beam by said light and/or heat sensitive material.

57. The apparatus of claim 56, wherein said data storage device further comprises a photodetector array operable to detect a portion of laser light from said laser beam that has been at least in part reflected by said light and/or heat sensitive material.

58. The apparatus of claim 57, wherein said data storage device is further operable to adjust said laser beam based at least in part on laser light detected by said photodetector array.

59. The apparatus of claim 58, wherein said data storage device is further operable to, after a time delay, further adjust said laser beam based at least in part oh laser light detected by said photodetector array after said time delay.

60. The apparatus of claim 59, wherein said data storage device is further operable to adjust said laser beam at least in part by adjusting a signal applied to a laser.

61. The apparatus of claim 59, wherein said data storage device is further operable to adjust said laser beam at least in part by adjusting a power of a signal applied to a laser.
